(19) United States
(12) Patent Application Publication
(10) Pub. No.: US 2026/0017691 A1
(43) Pub. Date: Jan. 15, 2026

(54) EVENT-BASED PAYMENT TRANSFERS

(71) Applicant: Wells Fargo Bank, N. A., San Francisco, CA (US)

(72) Inventor: Alan W. Hecht, Richmond, CA (US)

(21) Appl. No.: 19/267,289

(22) Filed: Jul. 11, 2025

Related U.S. Application Data
(60) Provisional application No. 63/670,517, filed on Jul. 12, 2024.

(51) Int. Cl. G06Q 30/0251; G06Q 20/22; G06Q 20/40; G06Q 40/03

(52) U.S. Cl. CPC G06Q 30/0271; G06Q 20/229; G06Q 20/405; G06Q 40/039

(57) ABSTRACT

Various systems and methods for managing event-based payment transfers are described herein. A system for managing event-based payment transfers is configured to determine an occurrence of an event associated with a first financial account at a first financial institution held by an accountholder; evaluate rules established by the accountholder to determine a funding source to use based on the event, wherein the funding source is a second financial account held by the accountholder at a second financial institution; initiate a money transfer of an amount from the funding source to the first financial account; and initiate presentation of a transaction summary to a user device of the accountholder, the transaction summary including details about the money transfer.

### CLAIM TO PRIORITY

This application claims the benefit of priority to U.S. Provisional Patent Application Ser. No. 63/670,517, filed Jul. 12, 2024, which is incorporated by reference herein in its entirety.

### BACKGROUND

There are many different methods of transferring money from one bank to another bank including wire transfers, automated clearing house (ACH) transfers, peer-to-peer payment services, personal checks, cashier's checks, banking application programming interfaces (API), financial technology (Fintech) platforms, and more. Each of these methods has its specific use cases, advantages, and disadvantages, and the choice of method depends on factors such as the speed required, the amount being transferred, the cost, and whether the transfer is domestic or international.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating an operating environment, according to an embodiment;

FIG. 2 is a flow diagram illustrating a process for providing notifications for deposits to an account, according to an embodiment;

FIG. 3 is a flow diagram illustrating a process for providing notifications for debits from an account, according to an embodiment;

FIG. 4 is an example user interface of an application used to configure rules, according to an embodiment;

FIG. 5 is a flowchart illustrating a method for managing event-based payment transfers, according to an embodiment; and

FIG. 6 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Systems and methods described herein provide an event-based payment transfer system. In modern society, the banking and finance industry has become enormously complex. Customers often have accounts at different banking institutions. While some banking systems allow for event-based payments, there is a need for a mechanism to provide a rules-based, automated payment transfer system between different banks.

The present systems and methods include an electronic system that is configured by a set of rules established by a banking customer. The electronic system is capable of monitoring a status of an account held by the banking customer. When an event occurs that is relative to the status of the account, the electronic system is able to request, demand, or otherwise initiate the transfer of funds from one or more external funding sources (e.g., a bank account at a different bank). The type of funding source, payment system used, and conditions of conducting transfers is configurable by the banking customer. These functions and others are described in more detail below.

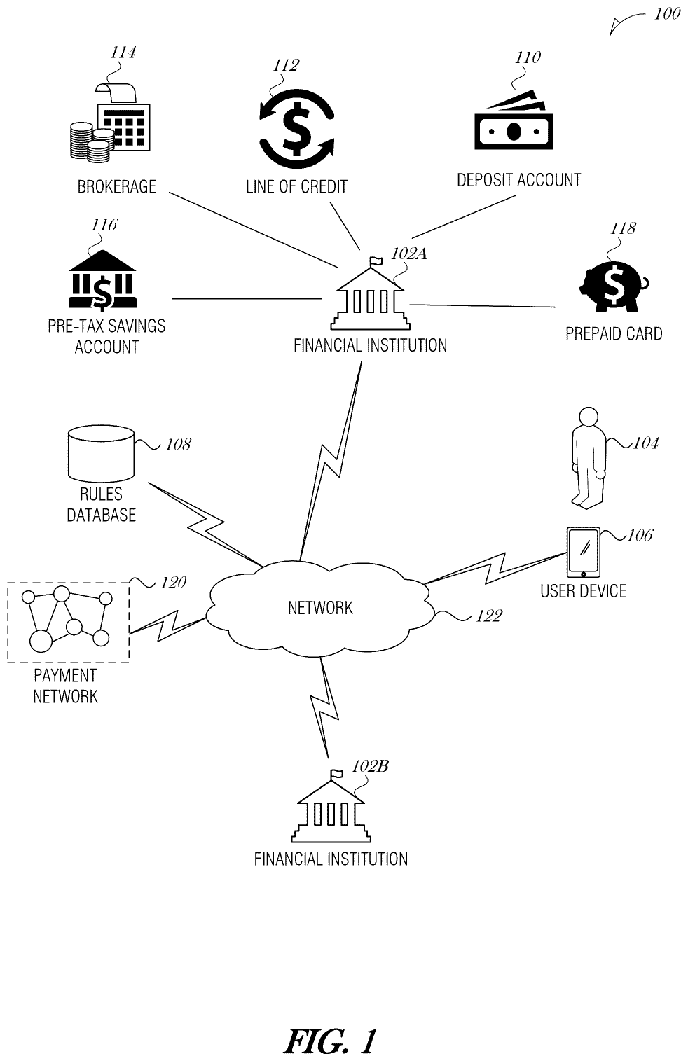

FIG. 1 is a diagram illustrating an operating environment 100, according to an embodiment. The entities illustrated in the operating environment 100 include a first financial institution system 102A, and a second financial institution system 102B. Financial institution systems 102A-B may be a bank, a credit union, an online bank, a brokerage firm, or the like that is able to provide various types of financial products to the user 104.

The financial institution systems 102A-B may provide a deposit account 110, line of credit 112, investment or brokerage account 114, pre-tax savings account 116, prepaid card 118, or the like. The deposit account 110 may be a checking, savings, money market, or other account where the user 104 is able to deposit and withdraw money. The line of credit 112 may be a credit card, home equity line of credit (HELOC), personal loan, or other type of credit provided to the user 104 by financial institution systems 102A-B. The brokerage account 114 may be a holding account for uninvested funds. The pre-tax savings account 116 may include health savings accounts (HSA), flexible spending accounts (FSA), heath reimbursement arrangement accounts (HRA), or the like.

A prepaid card 118 is also referred to as a reloadable debit card. A user 104 may use a prepaid card 118 in much the same was as a standard credit card or debit card. The key difference is that the prepaid card 118 is not linked to a line of credit 112. Instead, a prepaid card 118 is loaded (e.g., funded) with some amount of money. The prepaid card 118 may have a maximum value (e.g., a maximum amount that can be loaded on the prepaid card 118). As the user 104 purchases things or services and uses the prepaid card 118, the balance is reduced to reflect these purchases. The user 104 may reload the prepaid card 118 by funding it, for example, from a deposit account 110.

A user 104 (e.g., customer) has at least one account at each of the first financial institution system 102A and the second financial institution system 102B. As an illustrative example, the user 104 may have a checking, savings, and credit card accounts with financial institution system 102A and then only have a savings account at financial institution system 102B. The user 104 may have access to online resources at the financial institution systems 102A-B. The user 104 may download or otherwise obtain an application provided by the issuing bank 102. The application may be installed on a user device 106. The user device 106 may be of any type of mobile device including, but not limited to a smartphone, a laptop computer, a tablet device, a personal digital assistant, a wearable device (e.g., a smartwatch), or the like. The user 104 may use the application to configure accounts at the financial institution systems 102A-B.

While the user 104 may be able to perform reporting types of transactions with the online financial institution systems 102A-B, such as obtaining a balance, viewing recent transactions, or obtaining tax documents for a checking account, savings account, loan account, etc., the user 104 is also able to configure event-based payment transactions.

A payment transaction is a transaction that involves debiting one financial account and crediting another financial account with at least some of the funds. There may be fees associated with the transaction that reduce the amount that is credited to less than the amount debited. A transaction is either classified as a “push” transaction or a “pull” transaction, depending on which party initiates the transaction. A push payment transaction is one that is initiated from the account being debited. The push payment transaction pushes the funds to the account being credited. Conversely, a pull payment transaction is one that is initiated from the credited (receiver) account. Here, the receiving account requests, asks, demands, or otherwise takes funds from the account being debited.

Using an application to access the first financial institution system 102A, the user 104 may configure one or more rules, which are activated on a condition (event) to initiate a pull payment transaction from the second financial institution system 102B. In this way, a user 104 who has accounts at different banks is able to move money between accounts as if the accounts were at the same bank.

The rules may be defined using an application on the user device 106. The rules are stored in a rules database 108. A rule includes a target account (the account to receive funds), a source account (the account to provide funds), a condition (e.g., a logical test based on various aspects of the target account), a name, and other data to organize, operate, or identify the rule. When an event occurs on an account with a rule applied, then a pull payment transaction is initiated from the target account to have funds transferred from the source account. The event may be a low balance e.g., a balance below a user-configurable amount, an overdraft event, or other types of events where funds are needed to be deposited in the target account.

The pull payment transaction is performed using a payment network 120, which acts as an intermediary, routing the transaction information to the source account (e.g., financial institution system 102B) and then handling the transfer of funds from the source account (e.g., financial institution system 102B) to the target account (e.g., financial institution system 102A). The payment network 120 may include ACH, Zelle®, FedNow®, Real-Time Payments (RTP), Visa, Mastercard, Discovery, and the like.

Zelle®, FedNow®, and RTP are instant payment networks. This speed of payment is important and useful when refunding an overdrawn account or when replenishing an account that is running low. Zelle® is a fast, safe and easy way to send money to, and receive money from, people and eligible small businesses who have a bank account in the U.S. Transactions are typically completed in minutes when both sender and receiver are already enrolled with Zelle®. The FedNow Service is a new instant payment infrastructure developed by the Federal Reserve that allows eligible depository institutions of different sizes across the U.S. to provide instant payment services. RTP (Real-Time Payments) is a payment processing network used to send money electronically between banks in the United States. It transfers funds between two bank accounts instantaneously.

As an example, the user 104 may have a debit card with the first financial institution system 102A, where the debit card draws from a checking account at the first financial institution system 102A. As the user 104 purchases items, the user 104 may accidentally overdraft the underlying checking account. However, the user 104 may establish a rule such that if the checking account at the first financial institution system 102A is overdrawn, then an amount (e.g., a specific dollar amount or an amount related to the transaction that caused the overdraft) is requested from a second checking account that the user 104 has at the second financial institution system 102B.

As another example, the user 104 may have a credit card account with the first financial institution system 102A. Monthly, when a payment is due on the credit card account, the user 104 may pay for the credit card balance, either in part or in full, from an account at the second financial institution system 102B. For instance, the user 104 may have a checking account at the second financial institution system 102B, which when the payment due event occurs, is automatically drawn from. The credit card payment may be set up using a rule.

Instead of a credit card, the user 104 may have a prepaid card the first financial institution system 102A. A rule may be configured such that when the balance of available funds on the prepaid card falls below a threshold dollar amount, a savings account at the second financial institution system 102B is used to replenish the prepaid card's balance. It is understood that other types of accounts may be used as either source or target accounts, where the accounts do not have to be with the same financial institution.

The payment request may be performed using either a “request for payment” (RFP) mechanism or a debit pull mechanism. In an RFP transaction, the target account transmits a request to the source account for payment. Typically, the owner of the source account has to approve the payment before funds are released to the target account. When the owner of the account is the same person, then that person ends up having to both initiate the payment and then approve it before it completes. This is burdensome and illogical as it is the same person who owns both accounts.

In a debit pull transaction, a binding is created between the target account and the source account such that the source account is able to trust the target account and preauthorizes any requests for payment. The preauthorization may be limited, for example, to a threshold amount of money per day or per month, a threshold number of transactions per day or per month, or the like. The preauthorization may be managed by the user 104 to set limits or enable/disable constraints. These settings may be made at either the financial institution of the source account or the target account, or both.

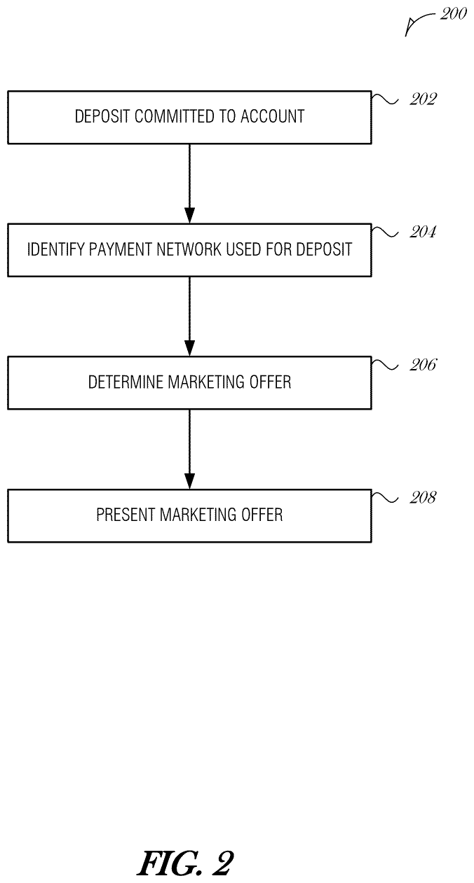

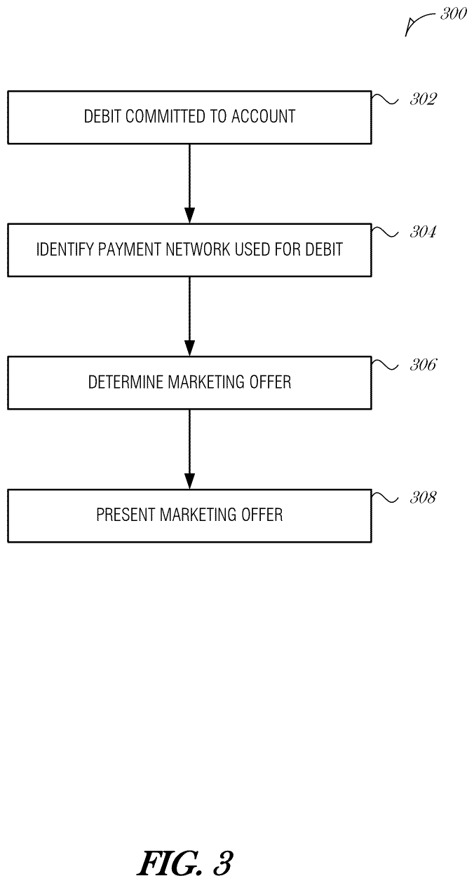

The user 104 may be provided various alerts, notifications, marketing offers, or other information when funds are pulled to an account (e.g., credited) or when funds are pushed to an account (e.g., debited). Notifications may appear on both sides of the transaction from different financial institution systems 102A-B. For example, funds may be pulled from a target account at the first financial institution system 102A from a source account at the second financial institution system 102B. When this occurs, the user 104 may receive a notification (e.g., text, email, voicemail, etc.) from the first financial institution system 102A about the pull deposit (money in) transaction and the second financial institution system 102B about a debit (money out) transaction. This is described more in FIGS. 2-3.

The financial institution systems 102A-B, user device 106, and payment network 120 may be connected via a network 122. The network 122 may include one or more of local-area networks (LAN), wide-area networks (WAN), wireless networks (e.g., 802.11 or cellular network), the Public Switched Telephone Network (PSTN) network, ad hoc networks, cellular, personal area or peer-to-peer networks (e.g., Bluetooth®, Wi-Fi Direct), or other combinations or permutations of network protocols and network types. The network 122 may include a single local area network (LAN) or wide-area network (WAN), or combinations of LANs or WANs, such as the Internet.

FIG. 2 is a flow diagram illustrating a process 200 for providing notifications for deposits to an account, according to an embodiment. As discussed herein, deposits may be a result of a pull payment transaction from another financial institution. Deposits may also be a result of a mobile deposit, an ATM deposit, an in-person teller deposit, or an electronic deposit.

At 202, a deposit is committed to an account. At 204, the payment network used to make the deposit is identified. The payment network (e.g., payment network 120), also referred to as a payment channel, payment rail, or payment processor, may be of various mechanisms, such as ACH, Zelle®, FedNow®, Real-Time Payments (RTP), Visa, Mastercard, Discovery, and the like.

At 206, a marketing offer is determined based on the account that was credited by the deposit, the payment network used for the deposit, along with other factors related to the deposit transaction.

At 208, the marketing offer is presented to the customer (e.g., user 104). The offer may be presented using a variety of different mechanisms, including an email, popup alert or notification on a mobile device, push notifications, digital advertising in a mobile app or on a financial institution's website, or the like. The marketing offer may be personalized to the customer. In general, the marketing offer may Leverage transaction detail to incent savings, investments, and enhanced value add services offered by the financial institution of the deposit account. Several use cases are provided here for illustration. These are not limiting examples.

A deposit or “money in” transaction may occur for many reasons, such as receiving an electronic deposit of a paycheck, receiving payment for something the customer sold, receiving a check or cash deposit, or the like. In the case of a mobile deposit (e.g., mobile check deposit) or a deposit at an ATM or a human teller, the transaction is a push transaction from the depositor's point of view. In most cases, the depositor is the owner of the account.

If the depositor is using a mobile app to deposit a check, then an offer may be presented to guide the customer to use Zelle® instead of checks. A prompt may be provided to have the customer receive future payments using Zelle®. If the customer consents, then the customer may be led through a process to register the customer and/or the payer to Zelle® so that in future transactions, Zelle® can be used instead of a check. Digital invoicing may be promoted through the use of offers as well. For instance, a small business may be prompted to enroll in various banking products, such as merchant services, credit line, Zelle®, receivable, ACH, payables, etc. Offers may be constructed based on who the payee is or what the payment was meant for (e.g., by optical character recognition (OCR) the memo line of a check). Offers may be presented in an ATM display at the time of deposit to promote the use of Zelle® or another instant cash transfer system.

In other instances, a deposit transaction is initiated by the receiving account in a pull deposit transaction. In the case of an IFI (international financial institution) money pull, offers may be constructed to use Zelle® as a first option as it results in quicker settlement and lower interchange rates. Using Zelle®, either a request-for-payment model or a realtime pull model may be used. If Zelle® is not selected, then use of RTP or FedNow® may be used with a Routing Transit Number (RTN) and account number. Alternatively, ACH may be used with an RTN and account number to pull money into the target account as a deposit. Various offers may be designed to drive business to Zelle® over RTP, FedNow®, or ACH.

FIG. 3 is a flow diagram illustrating a process 300 for providing notifications for debits from an account, according to an embodiment. Debits, also referred to as “money out” transactions, may be caused by various actions such as a bill pay, transferring money to an external investment account, transferring money to an e-wallet, transferring money to another financial institution, or even cash withdrawals at an automated teller machine (ATM).

At 302, a debit from an account is detected. At 304, the payment network used to commence the debit is identified. The payment network (e.g., payment network 120), also referred to as a payment channel, payment rail, or payment processor, may be of various mechanisms, such as ACH, Zelle®, FedNow®, Real-Time Payments (RTP), Visa, Mastercard, Discovery, and the like.

At 306, a marketing offer is determined based on the account that was debited, the payment network used for the debit, along with other factors related to the debit transaction. For instance, in a bill pay debit, the payee may be identified. The payee, which may be a business, a person, a charity, a government agency, or the like, may provide insight into the

At 308, the marketing offer is presented to the customer (e.g., user 104). The offer may be presented using a variety of different mechanisms, including an email, popup alert or notification on a mobile device, push notifications, digital advertising in a mobile app or on a financial institution's website, or the like. The marketing offer may be personalized to the customer. In general, the marketing offer may Leverage transaction detail to incent savings, investments, and enhanced value add services offered by the financial institution of the deposit account. Several use cases are provided here for illustration. These are not limiting examples.

When a customer uses a bill pay service to pay a business or person for goods or services, the customer may use various payment mechanisms. In many cases, a financial institution may want to drive customers to use Zelle® as it offers quicker settlement and less expensive transaction fees. Thus, when a customer uses ADP or a pay by check to pay a bill, a notification may be generated and presented to the customer to consider using Zelle®. Various workflows may be used to streamline the customer's enrollment or the payee's enrollment into Zelle® in order to streamline adoption.

For instance, in a bill pay user interface, a customer may be first presented a list of possible payees. After the customer selects a payee, then the customer may be asked to select a payment network (e.g., Zelle®, FedNow®, ACH, etc.). If a binding is set up, then the customer may use Zelle® from one account at one financial institution to another account at a different financial institution. If there is no binding, a customer may be guided through the process to create one. Otherwise, the customer may use Routing Transit Number (RTN) and account number to designate the external payee account.

Business data may be obtained from a centralized financial service, such as Fiserv or Mastercard. Using the business data, a Zelle® token may be determined and used to employ a Zelle® bill pay transaction.

Based on the reason or purpose of payment (e.g., mortgage, landscaping, etc.), one or more offers may be generated and presented to the customer. The offers may be directed to advertising financial products of the issuing bank.

Similarly, when there are outgoing payments to investment companies, brokers, life insurance, or other types of financial instruments, an offer may be generated to advertise an investment cash service account of the issuing bank. Similarly, when there are outgoing payments to an e-wallet or a Fintech system, an offer may be generated to advertise an e-wallet of the issuing bank.

When the money out transaction is an ATM withdrawal, the customer may be presented an offer to use Zelle® instead for a more secure and simple way of paying for whatever service or product the customer was withdrawing money for. For example, the customer may be withdrawing money to pay a babysitter. Instead of giving him cash, the customer may be guided through the use of person-to-person Zelle® transfers.

When using Zelle® through a mobile application of the issuing bank, the user may scan a Quick Response (QR) code of the payee, which is an encoded token for the payee. As another example, the user may use a camera app to scan the QR code and then be automatically redirected to the issuing bank's mobile app to complete the transaction (e.g., select the debit account, indicate the amount to send, and confirm).

Through the use of NameDrop from Apple® or other near-field technologies to share one's contact information, a Zelle® registration for a new payee may be initiated. This further streamlines a person-to-person payment when the people are conducting an in-person transaction. Offers may be presented to one or both of the users in this situation.

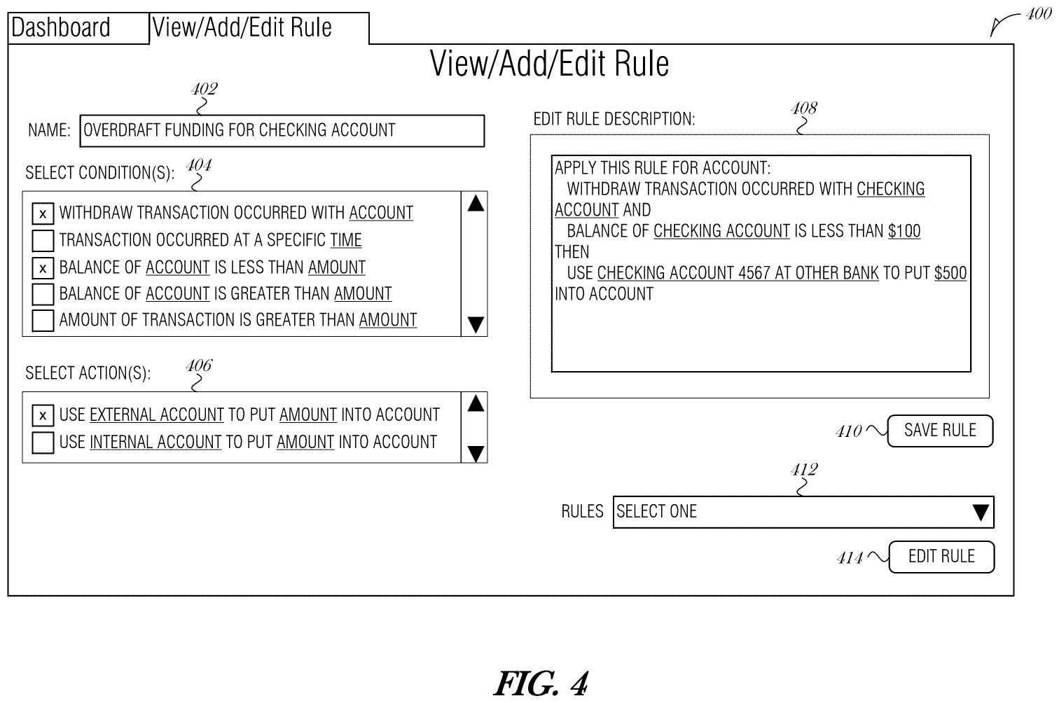

FIG. 4 is an example user interface 400 of an application used to configure rules, according to an embodiment. To add a new rule, a user may provide a name for the rule in a rule name text input control 402. Then the user may select one or more conditions from the conditions control 404. The conditions listed in the conditions selection control 404 are merely examples. More or fewer conditions may be implemented. The user may then select one or more actions from the actions selection control 406.

When a user selects a condition from the conditions selection control 404, the condition is added to the rule description 408. Similarly, when the user selects an action from the actions selection control 406, it is added to the rule description 408. In the rule description 408, the user may further define the condition or the action. In the example illustrated in FIG. 4, the conditions and actions include underlined portions. These underlined portions indicate the configurable portion of the rule. For instance, when the user selects the condition about the “external account”, a popup window or other user interface may be provided to the user to select or input the account to use in the condition. The financial institution system may automatically determine the payment network to use based on the account selected. For instance, if a binding exists for Zelle between the internal account (e.g., checking account) and the external account (e.g., “savings account 4567 at other bank”), then the Zelle payment rail may be used. In other embodiments, the user may be able to configure which payment network to use for a particular action. Once the user has the rule defined, the save button 410 is used to save the rule's settings.

To edit an existing rule, the user may use the select rule dropdown control 412 to select a rule and then when the user presses the edit button 414, the rule and its details are displayed in the rule name text input control 402, conditions selection control 404, actions selection control 406, and rule description 408. The user may modify various attributes of the rule and then save it to overwrite the existing rule.

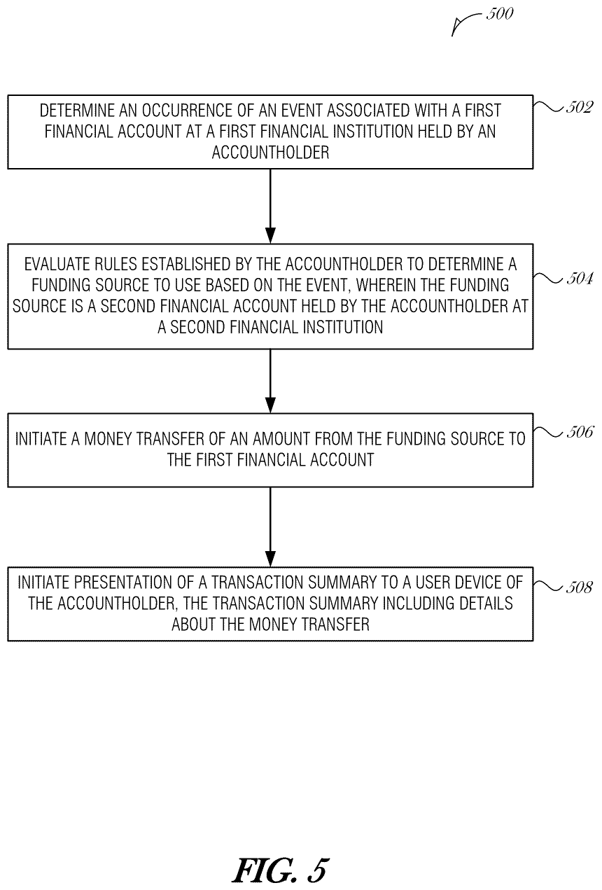

FIG. 5 is a flowchart illustrating a method 500 for managing event-based payment transfers, according to an embodiment. The method 500 may be performed by an electronic online system (e.g., financial institution systems 102A-B, user device 106, payment network 120) or any of the modules, logic, circuits, processors, or components described herein.

At 502, the method 500 includes the operation of determining an occurrence of an event associated with a first financial account at a first financial institution held by an accountholder. In an embodiment, the event includes a low balance alert on the first financial account. In an embodiment, the event includes an overdraft alert on the first financial account.

At 504, the method 500 includes the operation of evaluating rules established by the accountholder to determine a funding source to use based on the event, where the funding source is a second financial account held by the accountholder at a second financial institution.

At 506, the method 500 includes the operation of initiating a money transfer of an amount from the funding source to the first financial account. In an embodiment, the amount is based on an evaluation of the rules established by the accountholder. In an embodiment, the amount of the money transfer is a fixed amount. In an embodiment, the amount of the money transfer is a variable amount. In an embodiment, the amount of the money transfer is based on a minimum payment due to the first financial account.

At 508, the method 500 includes the operation of initiating presentation of a transaction summary to a user device of the accountholder, the transaction summary including details about the money transfer. In an embodiment, the details include a marketing offer. In a further embodiment, the marketing offer is generated based on the funding source.

In a further embodiment, the method 500 includes creating a binding between the first financial account and the second financial account. The binding is used to establish trust between the first and second financial accounts and preauthorizes any requests for payment from one account from the other.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

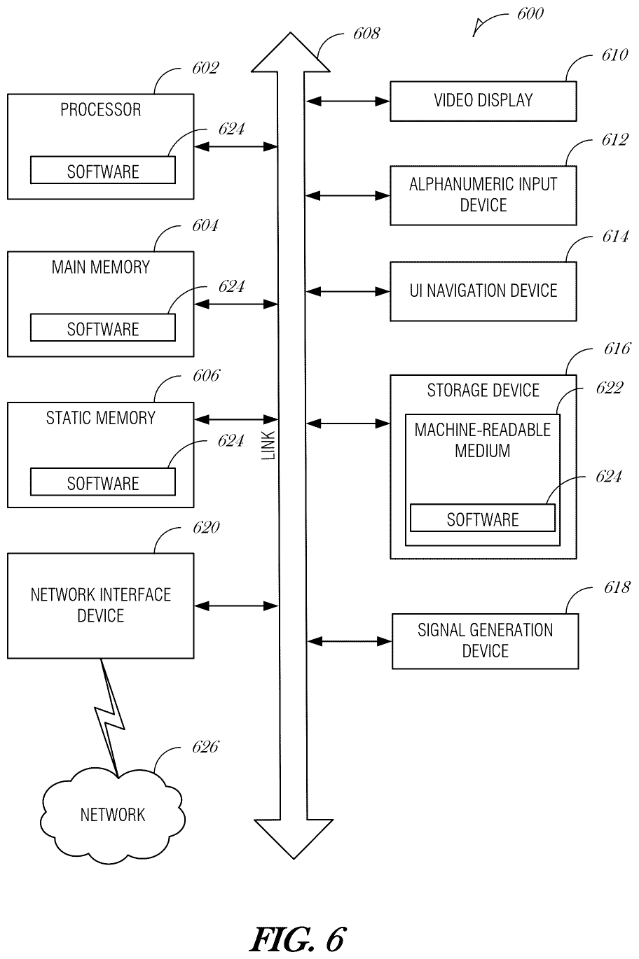

FIG. 6 is a block diagram illustrating a machine in the example form of a computer system 600, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, set-top box, wearable device, personal computer (PC), a tablet PC, a hybrid tablet, a personal digital assistant (PDA), a mobile telephone, cloud server, web server, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 600 includes at least one processor 602 (e.g., a central processing unit (CPU), a graphics processing unit (GPU) or both, processor cores, compute nodes, etc.), a main memory 604 and a static memory 606, which communicate with each other via a link 608 (e.g., bus). The computer system 600 may further include a video display unit 610, an alphanumeric input device 612 (e.g., a keyboard), and a user interface (UI) navigation device 614 (e.g., a mouse). In one embodiment, the video display unit 610, input device 612 and UI navigation device 614 are incorporated into a touch screen display. The computer system 600 may additionally include a storage device 616 (e.g., a drive unit), a signal generation device 618 (e.g., a speaker), a network interface device 620, and one or more sensors (not shown), such as a global positioning system (GPS) sensor, compass, accelerometer, or other sensor.

The storage device 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604, static memory 606, and/or within the processor 602 during execution thereof by the computer system 600, with the main memory 604, static memory 606, and the processor 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 624. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### ADDITIONAL NOTES & EXAMPLES

Example 1 is a system for managing event-based payment transfers, the system comprising: a processor subsystem; and memory including instructions, which when executed by the processor subsystem, cause the processor subsystem to: determine an occurrence of an event associated with a first financial account at a first financial institution held by an accountholder; evaluate rules established by the accountholder to determine a funding source to use based on the event, wherein the funding source is a second financial account held by the accountholder at a second financial institution; initiate a money transfer of an amount from the funding source to the first financial account; and initiate presentation of a transaction summary to a user device of the accountholder, the transaction summary including details about the money transfer.

In Example 2, the subject matter of Example 1 includes, wherein the event includes a low balance alert on the first financial account.

In Example 3, the subject matter of Examples 1-2 includes, wherein the event includes an overdraft alert on the first financial account.

In Example 4, the subject matter of Examples 1-3 includes, wherein the instructions cause the processor subsystem to create a binding between the first financial account and the second financial account.

In Example 5, the subject matter of Examples 1˜4 includes, wherein the amount is based on an evaluation of the rules established by the accountholder.

In Example 6, the subject matter of Examples 1-5 includes, wherein the details include a marketing offer.

In Example 7, the subject matter of Example 6 includes, wherein the marketing offer is generated based on the funding source.

In Example 8, the subject matter of Examples 1-7 includes, wherein the amount of the money transfer is a fixed amount.

In Example 9, the subject matter of Examples 1-8 includes, wherein the amount of the money transfer is a variable amount.

In Example 10, the subject matter of Examples 1-9 includes, wherein the amount of the money transfer is based on a minimum payment due to the first financial account.

Example 11 is a method for managing event-based payment transfers, the method performed on an electronic online system, the method comprising: determining an occurrence of an event associated with a first financial account at a first financial institution held by an accountholder; evaluating rules established by the accountholder to determine a funding source to use based on the event, wherein the funding source is a second financial account held by the accountholder at a second financial institution; initiating a money transfer of an amount from the funding source to the first financial account; and initiating presentation of a transaction summary to a user device of the accountholder, the transaction summary including details about the money transfer.

In Example 12, the subject matter of Example 11 includes, wherein the event includes a low balance alert on the first financial account.

In Example 13, the subject matter of Examples 11-12 includes, wherein the event includes an overdraft alert on the first financial account.

In Example 14, the subject matter of Examples 11-13 includes, creating a binding between the first financial account and the second financial account.

In Example 15, the subject matter of Examples 11-14 includes, wherein the amount is based on an evaluation of the rules established by the accountholder.

In Example 16, the subject matter of Examples 11-15 includes, wherein the details include a marketing offer.

In Example 17, the subject matter of Example 16 includes, wherein the marketing offer is generated based on the funding source.

In Example 18, the subject matter of Examples 11-17 includes, wherein the amount of the money transfer is a fixed amount.

In Example 19, the subject matter of Examples 11-18 includes, wherein the amount of the money transfer is a variable amount.

In Example 20, the subject matter of Examples 11-19 includes, wherein the amount of the money transfer is based on a minimum payment due to the first financial account.

Example 21 is a non-transitory machine-readable medium comprising instructions for managing event-based payment transfers, which when executed by a machine in an online system, cause the machine to: determine an occurrence of an event associated with a first financial account at a first financial institution held by an accountholder; evaluate rules established by the accountholder to determine a funding source to use based on the event, wherein the funding source is a second financial account held by the accountholder at a second financial institution; initiate a money transfer of an amount from the funding source to the first financial account; and initiate presentation of a transaction summary to a user device of the accountholder, the transaction summary including details about the money transfer.

In Example 22, the subject matter of Example 21 includes, wherein the event includes a low balance alert on the first financial account.

In Example 23, the subject matter of Examples 21-22 includes, wherein the event includes an overdraft alert on the first financial account.

In Example 24, the subject matter of Examples 21-23 includes, wherein the instructions cause the machine to create a binding between the first financial account and the second financial account.

In Example 25, the subject matter of Examples 21-24 includes, wherein the amount is based on an evaluation of the rules established by the accountholder.

In Example 26, the subject matter of Examples 21-25 includes, wherein the details include a marketing offer.

In Example 27, the subject matter of Example 26 includes, wherein the marketing offer is generated based on the funding source.

In Example 28, the subject matter of Examples 21-27 includes, wherein the amount of the money transfer is a fixed amount.

In Example 29, the subject matter of Examples 21-28 includes, wherein the amount of the money transfer is a variable amount.

In Example 30, the subject matter of Examples 21-29 includes, wherein the amount of the money transfer is based on a minimum payment due to the first financial account.

Example 31 is at least one machine-readable medium including instructions that, when executed by processing circuitry, cause the processing circuitry to perform operations to implement of any of Examples 1-30.

Example 32 is an apparatus comprising means to implement of any of Examples 1-30.

Example 33 is a system to implement of any of Examples 1-30.

Example 34 is a method to implement of any of Examples 1-30.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system for managing event-based payment transfers, the system comprising:
a processor subsystem; and
memory including instructions, which when executed by the processor subsystem, cause the processor subsystem to:
determine an occurrence of an event associated with a first financial account at a first financial institution held by an accountholder;
evaluate rules established by the accountholder to determine a funding source to use based on the event, wherein the funding source is a second financial account held by the accountholder at a second financial institution;
initiate a money transfer of an amount from the funding source to the first financial account; and
initiate presentation of a transaction summary to a user device of the accountholder, the transaction summary including details about the money transfer.

2. The system of claim 1, wherein the event includes a low balance alert on the first financial account.

3. The system of claim 1, wherein the event includes an overdraft alert on the first financial account.

4. The system of claim 1, wherein the instructions cause the processor subsystem to create a binding between the first financial account and the second financial account.

5. The system of claim 1, wherein the amount is based on an evaluation of the rules established by the accountholder.

6. The system of claim 1, wherein the details include a marketing offer.

7. The system of claim 6, wherein the marketing offer is generated based on the funding source.

8. The system of claim 1, wherein the amount of the money transfer is a fixed amount.

9. The system of claim 1, wherein the amount of the money transfer is a variable amount.

10. The system of claim 1, wherein the amount of the money transfer is based on a minimum payment due to the first financial account.

11. A method for managing event-based payment transfers, the method performed on an electronic online system, the method comprising:
determining an occurrence of an event associated with a first financial account at a first financial institution held by an accountholder;
evaluating rules established by the accountholder to determine a funding source to use based on the event, wherein the funding source is a second financial account held by the accountholder at a second financial institution;
initiating a money transfer of an amount from the funding source to the first financial account; and
initiating presentation of a transaction summary to a user device of the accountholder, the transaction summary including details about the money transfer.

12. The method of claim 11, wherein the event includes a low balance alert on the first financial account.

13. The method of claim 11, wherein the event includes an overdraft alert on the first financial account.

14. The method of claim 11, comprising creating a binding between the first financial account and the second financial account.

15. The method of claim 11, wherein the amount is based on an evaluation of the rules established by the accountholder.

16. A non-transitory machine-readable medium comprising instructions for managing event-based payment transfers, which when executed by a machine in an online system, cause the machine to:
determine an occurrence of an event associated with a first financial account at a first financial institution held by an accountholder;
evaluate rules established by the accountholder to determine a funding source to use based on the event, wherein the funding source is a second financial account held by the accountholder at a second financial institution;
initiate a money transfer of an amount from the funding source to the first financial account; and
initiate presentation of a transaction summary to a user device of the accountholder, the transaction summary including details about the money transfer.

17. The non-transitory machine-readable medium of claim 16, wherein the event includes a low balance alert on the first financial account.

18. The non-transitory machine-readable medium of claim 16, wherein the event includes an overdraft alert on the first financial account.

19. The non-transitory machine-readable medium of claim 16, wherein the instructions cause the machine to create a binding between the first financial account and the second financial account.

20. The non-transitory machine-readable medium of claim 16, wherein the amount is based on an evaluation of the rules established by the accountholder.
